(19) United States
(12) Patent Application Publication
(10) Pub. No.: US 2009/0143882 A1
(43) Pub. Date: Jun. 4, 2009

(54) Machine and Method for Caddying and Golf Instruction

(76) Inventor: Julius Young, Osprey, FL (US)

Correspondence Address: Julius Young, 3832 Virga Blvd, Sarasota, FL, 34233, US

(21) Appl. No.: 11/949,765

(22) Filed: Dec. 3, 2007

(51) Int. Cl. G06F 19/00; A63B 57/00

(52) U.S. Cl. 700/91; 473/131

(57) ABSTRACT

The present invention relates to a machine and method used to capture, analyze, score, archive, track and communicate real-time relevant golf data specific to individual golfers: 1) during practice/lessons; or 2) for every shot on every hole of an entire recreational golf round; and 3) archive all such practice sessions or rounds during which the invention is in use. Additionally it could be used to support a foursome or an entire tournament for those participants using the invention.

### FIELD OF THE INVENTION

The present invention relates to a machine and method used to capture, analyze, score (i.e. using USGA rules), archive, track and communicate (verbal and/or display) real-time relevant golf data specific to individual golfers: 1) during practice/lessons; or 2) for every shot on every hole of an entire recreational golf round; and 3) archive all such practice sessions or rounds during which the invention is in use. Additionally it could be used to support a foursome or an entire tournament for those participants using the invention.

### BACKGROUND OF THE INVENTION

The prior art contains literature, machines and processes that provide incomplete but relevant developments in some of the same technological areas as those necessary to fully implement the present invention.

These fall roughly into two categories. The first category relates to literature, machines and processes that provide real-time professional golf tournament and player information for the use and entertainment of golf enthusiast (i.e. spectators) and/or PGA Tour Professional Golfers but do not provide any such information for the average golfer.

For example, “TOURCast”™ is an online service for fans, available on PGATOUR.COM, which gives fans access to real-time tournament and player information at the click of a mouse. It uses a data collection and management solution called “ShotLink,”™ which provides real-time scoring information for PGA TOUR events. To put this complex ShotLink™ system in place, each course the TOUR plays was mapped. Using Global Positioning System (GPS) devices, different layers and elevations were recorded to denote the greens, fairways, bunkers, water, rough, trees and other course elements. During tournament play, walking scorers accompany each player pairing and use wireless handheld devices to record and transmit data (via satellite), including distance, lie, location and score, from every hole, for each player.

To supplement this data, several spotters operate sophisticated laser devices positioned at points along the fairway and on the green of each hole throughout the course to manually record the exact position of every ball. ShotLink™ represents a complete source of information for onsite event spectators. It is the data engine behind the tournaments, capturing every point, for every golfer, on every hole. This information is sent to the ShotLink™ trailer on site, as well as the laser operator volunteers. In addition, another key component, “TournamentTracker”™ is the front-end application that delivers real-time ShotLink™ content to the media, broadcasters and spectators at the event site using notebook computers.

This system uses very high tech machines and processes, it is also a very labor intensive process—requiring as many as 250 volunteers plus staff per Tour Event and approximately 10,000 volunteers to support 102 Tour Events a year, each of which could have a field of more than 100 players competing simultaneously on a 450-acre field; and it takes four days to play.

In light of these extensive support requirements, the use of such machines and processes as described above for the average golfer's round is impractical. Therefore there is a need for a fully automated more cost effective machine and method for providing real-time relevant golf data specific to the average golfer when practicing or taking lessons to become a better golfer or to increase the enjoyment of playing a recreational round of golf.

As for machines and processes that fall into the second category, these relate to machines and processes that offer diverse solutions to narrow segments of the spectrum of what is available to professional golfers on the PGA Tour™ as described above.

One of these is called SkyCaddie™, which is a handheld rangefinder that uses a powerful microprocessor, Global Positioning System (GPS), and satellite-based accuracy enhancement technology. The SkyCaddie™ automatically calculates, as you move, distances to up to forty targets per hole simultaneously in less than a second.

With a SkyPlayer™ membership, the golfer can choose from thousands of available SkyCourses™ from the SkyCaddie™ website to download to their SkyCaddie™. Similar to the ShotLink™ system described above, each downloaded course was mapped. Using GPS devices, different layers and elevations were recorded to denote the greens (front, center and back), fairways, bunkers, water, rough, trees and other course elements. If one wished to play non-mapped courses the golfer can record the front, center, and back of each green on such courses using the built-in SkyCourse™ Setup module.

A Golfer playing a round, starting on the first tee, would check the SkyCaddie™ to determine how far he was from the green and to check the terrain for hazards to avoid and safe areas to target his ball. The Golfer could then mark his location by pressing a button on the SkyCaddie, and then take his shot. When the Golfer reached his ball; he/she would already have the distance to the green and other mapped targets. At that point the ball location could be marked again and the display would show the distance the ball traveled with the previous shot. The green or an intermediate target could be selected and the next shot could be taken. The Golfer can continue to use the SkyCaddie™ in this way until the ball is holed and he/she moves on to the next hole. Note that the ranges are also mapped and can be used for practice.

The SkyCaddie™ also uses a very sophisticated tech system but has some shortcomings that can be improved. The golfer must take action to mark the ball to obtain distance information on each shot. The system does not capture, analyze, score, archive, track or communicate real-time relevant golf data. It does compute distance if the ball is marked but does not save the data.

Thus there is a need for a machine and method for automatically sensing the starting point and the ending point for each shot and that also provides real-time relevant golf data specific to the average golfer when practicing, taking lessons or playing a recreational round of golf.

Another machine in this category is called RadarGolf™, which uses radar technology to track and located a recreational golf ball. RadarGolf's Ball Positioning System™ technology helps you locate your golf ball quickly! Save time, penalty strokes and reduce the frustration of searching for golf balls.

The RadarGolf System™, using Ball Positioning System™ (BPS™) technology, consists of three main components. The handheld, Shield-It pouch and ball work together to save you strokes, time, and frustration. The ball contains a tiny chip. When it is struck and the golfer reaches the vicinity of where the golf ball “came down” but cannot locate the exact position of the ball, the handheld machine can be used to locate the ball. BPS™ technology uses advanced electronics to enable the handheld to transmit a specific radio frequency (RF) signal. When this signal reaches a RadarGolfBall™, the ball returns a separate specific RF signal. The handheld receiver is tuned to “listen” for the signal from the ball. An LCD provides visual feedback and an audio tone allows you to hone in on your lost ball. You will receive stronger feedback as you get closer to your ball. The Shield-It pouch is used to hold the extra balls not in play (i.e. shield them) so that they will not give false readings to the handheld.

This system does provide some cost effective features for the average golfer that the Tour Golfer has through its spotters and volunteers operating sophisticated laser devices that track ball fight and final location. However there are a number of drawbacks of this system as well. The RadarGolf System™ does not capture, analyze, score, archive, track or communicate real-time relevant golf data. It does locate some lost balls but only when the golfer reaches the vicinity (i.e. within range of 30-100 feet, depending on the terrain) of where the ball came to rest.

Thus there is a need for a machine and method for automatically locating the golf ball after each shot and that also provides real-time relevant golf data specific to the average golfer when practicing, taking lessons or playing a recreational round of golf.

Another machine that falls into the second category is the eCaddy™. That is, this machine together with its software offers a solution to a narrow segment of the spectrum of what is available to professional golfers on the PGA Tour™ as described above. Its focus is on measurements. The eCaddy™ is a digital scorecard that resembles a real scorecard. The top line (Title Field) shows the game and course numbers with the scoring method. The next 3 lines (Course Field) show the Hole Numbers, Pars and Hole Handicaps. The next 4 lines (Player field) show the four players' scores. The only difference from the paper card is that eCaddy shows 3 holes at a time while a paper card shows 9.

The eCaddy™ provides some of the data needed for analysis, as well as some historical information. It handles up to 4 players, 20 rounds of games, 10 courses. It provides totals for Current, Front, Back, Gross and Net. The shot breakdowns are Full Swing, Partial Swing and Putts. It keeps track of Driver Accuracy (Fairway, Left and Right Rough) as well as Sand Saves. After a round, one can interface the eCaddy™ with a PC using the eCaddyLyzer™ and do analysis such as: Handicap Index based on USGA rules, hole score breakdown, shot breakdown, greens-in-regulation, up and down, driver accuracy, sand saves, etc. The primary drawback of this system is that it is not an automated system and data entry is essentially a manual process. Usually such manual data entry is not practical because of the fast “pace of play” one is required to maintain on most golf courses. Also there are some important data elements that are not available such as distance data on ball striking.

Thus there is a need for a system that automates the data capture, scoring and shot analysis while it also archives, tracks and communicates real-time relevant golf data.

### SUMMARY OF THE INVENTION

Given all the advantages that the Personal Caddies, Spotters, Volunteer Laser Operators, etc. bring to the PGA Tour Professional and the inherent limitations of the dispirit machines and methods described above that are available to the average golfer, it is the object of the present invention to provide an apparatus or machine and method that overcome the issues and limitations in the discussion of the prior art.

The present invention comprises an apparatus or machine with a plurality of components and includes the use of an enhanced Global Positioning System (GPS) and a handheld computing device (PDA) for communicating with the GPS. It will further include a full set of enhanced Golf Clubs (USGA rules—containing 14 golf clubs) that may have at least one microchip, impact sensor, unique club identifier and/or pressure sensor integrated into each club or their equivalent capability in newer technology such as nanotechnology integrated into reengineered versions of these products. It will further include associated golf balls, golf shoes and golf gloves (all of which may have at least one microchip, impact sensor, unique identifiers and/or pressure sensor integrated into each one; or their equivalent capability in newer technology such as nanotechnology integrated into reengineered versions of these products). These enhanced golf balls, clubs, shoes and gloves would work passively in concert with the GPS system to 1) accurately sense when the club is picked up; 2) capture the pattern of how the club is being gripped in comparison to one of the acceptable grip standards such as the Verdon Overlap grip, the interlocking grip and the Ten Finger grip or a golfer's own predefined grip; 3) capture the golfer's setup such as body alignment, foot position, ball position, balance and posture. The enhanced golf balls, clubs, shoes and gloves will be designed to meet or exceed all performance criteria established by the USGA (at least for recreational play and/or as a training aid).

The enhancements to the golf ball will be made deep in its core and will be miniaturized (or use nanotechnology, for example using nanochips which could store trillions of bits of information in a very small area) so as not to affect the dynamics of the ball. The enhancements will be designed to withstand the forces exerted on them during normal play of golf rounds and would be expected to last as long as a typical recreational golf ball. One of the purposes of the enhanced golf ball will be to work in concert with the PDA and GPS to capture and record real-time ball information when struck; including but not limited to 1) ball dynamics such as spin; 2) starting and ending location, 3) distance and direction traveled; 4) distance to the pin; and 5) distance to mapped hazards.

The enhancements to the Golf Shoes will allow the system to capture (among other things) the direction and amount of weight shift of the golfer from one foot to the other throughout the golf swing.

Body sensors could also be integrated into the apparatus for use during practice and training sessions.

The specially designed and programmed handheld PDA will make use of existing operating systems and software (where available and with applicable modifications) to capture, analyze, score, archive, track and communicate real-time relevant golf data specific to individual golfers. The PDA will also make use of existing GPS mapped golf courses. With appropriate membership, the golfer can choose from thousands of available Golf Courses on the internet to download chosen courses to their handheld PDA. Similar to the ShotLink™ system described above, each downloaded course is mapped. Using GPS devices, different layers and elevations were recorded to denote the greens (front, center and back), fairways, bunkers, water, rough, trees and other course elements. If one wishes to play non-mapped courses the golfer can record similar information on such courses into their handheld PDA.

The Invention will further comprise the ability to link to a PC or other computer equipment for uploading and downloading information for analysis, review and study.

### BRIEF DESCRIPTION OF THE DRAWINGS

FIG. 1 shows a perspective view of the key components of the present invention.

### DETAILED DESCRIPTION OF THE FIRST EMBODIMENT OF THE INVENTION

Referring to the drawing figure listed above, the first embodiment of the present invention is an apparatus or machine comprising components which collectively work together to capture, analyze, score, archive, track and communicate real-time relevant golf data specific to individual golfers for every shot on every hole of an entire recreational golf round. The first embodiment of the apparatus or machine of the present invention will be described initially and then the method of using the apparatus will be described.

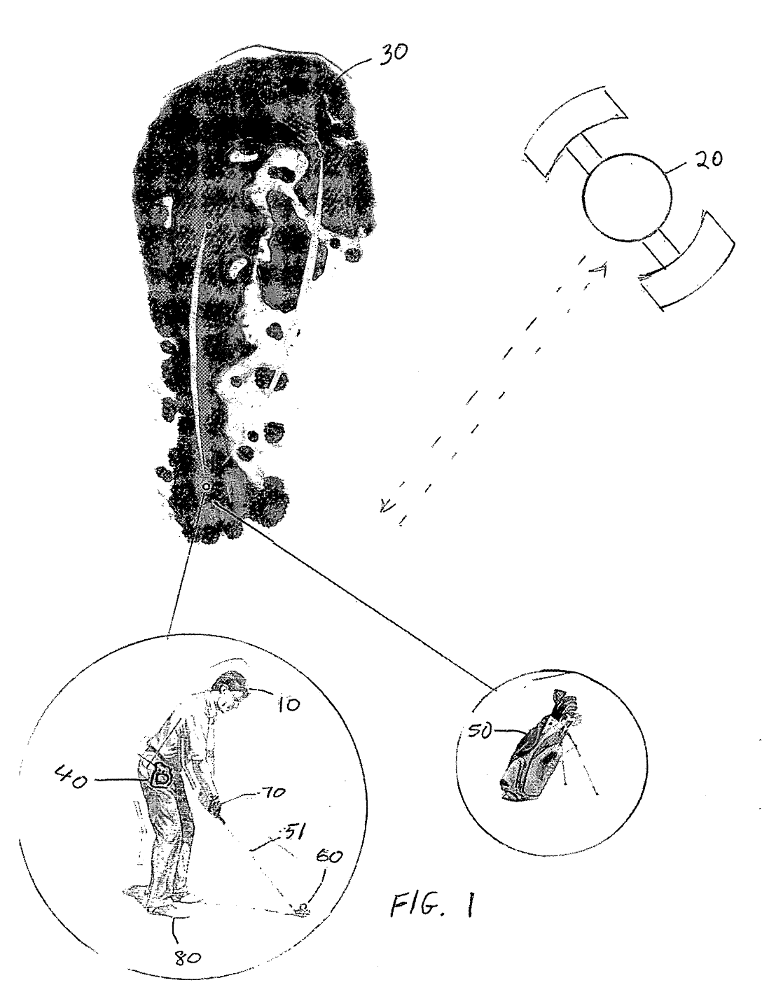

The golfer 10 is assumed to be using the apparatus or machine of the present invention shown in the perspective illustration of FIG. 1 and is comprised of the use of a Global Positioning System (GPS) satellite 20, a mapped golf course 30, a handheld computing device (PDA) 40, enhanced golfing equipment such as a set of Golf Clubs 50, golf ball 60, golf glove 70 and golfing shoes 80. The figure also shows the golfer 10 about to “tee-off” using his driver 51 golf club.

That completes the description of the major components of the first embodiment of the invention. Initially, for simplicity assume that there is only a single player for the round. Now attention will be focused on the method of using the first embodiment of the present invention during a round of golf at a GPS mapped golf course. It consists of three major steps: the first major step 1) is to prepare the PDA (preferably prior to arriving at the Golf Course) by downloading the applicable GPS mapped course information from the internet, provide information on type of play (e.g. stroke play vs. match play, set PDA in “caddy inform mode” including displayed and/or verbal advice vs. “record mode only”, “training mode” or “player performance and analysis mode”), ensure that the appropriate player information has been identified to the PDA (i.e. clubs, balls, gloves and shoes uniquely tied to each player), then upon arriving at the 1^{st} tee for the round, ensure that the PDA is on and operational with the starting hole shown on the PDA.

Continuing with the method of using the first embodiment the second major step: 2) is for the player to check the PDA screen for the characteristics of the entire hole including hazards, distances to fairway and greens or other strategic points, etc., then after deciding on a plan of approach for the hole, “tee off”; the system will automatically detect the club used once the golfer selects the club by griping its handle and it will record the starting ball location and dynamically capture key data relevant to the golfer's tee shot such as club used, club head speed at impact, ball spin, distance and direction of ball, and its location after it comes to rest. If the ball lands in an inaccessible location, the PDA can inform him of that and suggest a plan of approach (as his caddy) for the next shot consistent with the USGA rules, if the player has selected verbal and/or display “caddy inform mode”. If the ball is in a hazard area or out of bounds area that is so noted for scoring and to prevent the player from making a mistake by selecting an illegal drop (like any good caddy would do). If the player selected “record mode only”, the system (i.e. the PDA in conjunction with GPS) would remain silent but note any mistakes and assess a proper penalty (based on USGA rules) if the player mistakenly drops his ball in the wrong place for his next shot. Whether the ball from the previous shot was inaccessible or not, the location for the next shot would be determined. The player would then proceed to the location where the ball came to rest or the correct location for his next shot (if he has to drop a ball) and check the PDA screen for the characteristics of the hole from the new position of the ball, looking for hazards, distances to safe landing locations for his 2^{nd} shot or accessing whether he should try shooting for the green; upon deciding on a plan of approach for the 2^{nd} shot the player selects a club by griping its handle, set up for the shot and takes it. The player continues in this way until he reaches the green. This leads to the third and last major step.

Continuing with the method of using the first embodiment, the third major step: 3) is to closeout the hole and ensure that scores are accounted for all players as they “hole-out” their balls at each hole. Also all strokes are reconciled and recorded. The system will know that the player is now on the green because it knows the boundaries of the green. The system then tallies putting strokes until the player holes the ball. As a result of the fact that the system knows the contour of the topography around the greens and the golf clubs each player used, it can keep an accurate count of sand saves, pitches and chips as well as putts on the green. Scoring is automatic because the PDA in communication with GPS will use such known information as course played, hole pars, hole handicaps, player handicaps combined with the results of each shot taken (including penalty strokes, if any) to determine the score for the hole. At any point during the course of play, the player can make manual corrections to the scoring and other information in the PDA, but the system can keep track of corrections as an audit.

When the 1^{st} hole is completed, the player goes on to the 2^{nd} hole and repeats the 3 steps for the 2^{nd} hole and each subsequent hole through completion of the 9th hole, whereupon the system will tally the front 9 and the player can move on to the 1^{st} hole on the back 9. The entire 3 step process is then repeated for each hole in the back 9. Upon completion of the 18^{th} hole, the system tallies the back 9, the Gross and Net score for the player. In this way every shot on every hole of the entire recreational golf round is captured, scored and archived. The information is also available for review using the PDA. It can also be downloaded to a PC for analysis and for training.

What is claimed is:

1. An apparatus or machine used to capture, analyze, score (i.e. using USGA rules), archive, track and communicate real-time relevant golf data specific to individual golfers.

2. The apparatus or machine of claim 1, which comprises:
a handheld computing device (PDA),
a set of golf clubs containing the USGA standard number of 14 golf clubs,
at least one golf ball,
at least one golf glove,
a pair of golf shoes,
means for communicating with a Global Positioning System (GPS),
means for accessing and selecting a mapped golf course from a wide listing of mapped golf courses,
means for capturing, analyzing, scoring, archiving, tracking and communicating real-time relevant golf data specific to individual golfers.

3. The apparatus or machine of claim 2, wherein said PDA provides:
said means for communicating with a GPS,
said means for accessing and selecting a mapped golf course from a wide listing of mapped golf courses, and
said means for capturing, analyzing, scoring, archiving, tracking and communicating real-time relevant golf data specific to individual golfers.

4. The apparatus or machine of claim 2, wherein each said golf club comprises:
means for sensing when the golf club is gripped,
means for sensing when a shot is taken,
means for providing computing inside of said golf club.

5. The apparatus or machine of claim 4, wherein one way that said golf club provides: said means for sensing when the club is gripped consists of pressure sensors placed in the grip of the golf club,
said means for sensing when a shot is taken consists of embedding an impact sensitive device in the golf club or its shaft,
said means for providing computing inside of said golf club is a microchip embedded in the golf club head or its shaft.

6. The apparatus or machine of claim 2, wherein said golf ball is comprised of:
an embedded impact sensitive device in said golf ball,
means for sensing when said golf ball is hit with said golf club,
means for computing inside of said golf ball.

7. The apparatus or machine of claim 6, wherein one way that said golf ball provides:
means for sensing when said golf ball is hit with said golf club is through impact analysis captured by said embedded impact sensitive devices in the golf club and the golf ball,
means for computing inside said golf ball is to embed at least one microchip in the core of the golf ball.

8. The apparatus or machine of claim 2, wherein said golf glove is comprised of a means for sensing when the golfer's grip conforms to one of the predefined grip standards selected from the group consisting of the Verdon Overlap grip, the Interlocking grip and the Ten Finger grip.

9. The apparatus or machine of claim 2, wherein said pair of golf shoes is comprised of means for sensing when the golfer is not properly balanced during his golf shot.
